(19) United States
(12) Patent Application Publication
(10) Pub. No.: US 2004/0249731 A1
(43) Pub. Date: Dec. 9, 2004

(54) Methods and systems for automatic evaluation of balance sheet objects

(75) Inventors: Mathias Sonnek, Oberhausen-Reinhausen (DE); Stefan Schmid, Wiesloch (DE)

Correspondence Address: Finnegan, Henderson, Farabow,, Garrett & Dunner, L.L.P., 1300 I Street, N.W., Washington, DC, 20005-3315, US

(73) Assignee: SAP AKTIENGESELLSCHAFT, Walldorf (DE)

(21) Appl. No.: 10/809,383

(22) Filed: Mar. 26, 2004

(30) Foreign Application Priority Data
Mar. 27, 2003 (DE) 103 13 693.2

(51) Int. Cl. G06F 17/60

(52) U.S. Cl. 705/30

(57) ABSTRACT

Methods and systems are disclosed for automatic evaluation of balance sheet objects. In one embodiment, a book value for each object in an accounting system is automatically determined. A market value for each object is automatically determined. An intermediate variable from the book value and the market value is automatically formed. The intermediate variable is automatically tested to determine whether it satisfies one or more presettable conditions. One or more actions are performed depending upon the manner and/or degree that one or more of the conditions are satisfied.

### BACKGROUND OF THE INVENTION

I. Field of the Invention

The present invention generally relates to methods and systems for automatically evaluating balance sheet objects. More particularly, the present invention relates to the implementation of impairments, which are depreciations in value for an object or asset, such as securities.

II. Background Information

When the value of an object decreases, normally either a decrease in value is entered in an asset account, and at the same time, an offsetting entry is made in a reserve account, or no entry is made. In line with prior implementations, an impairment is formed as needed during this process. An impairment is formed when the value of an object decreases permanently and/or falls below a particular limit value. In such a case, any reserve that may exist is liquidated and an appropriate sum is posted as an expense affecting net income.

However, this approach has a drawback in that a considerable expense arises. In particular, all assets for an object need to be manually checked for a permanent decrease in value by the user on a regular basis. This checking is time-intensive and susceptible to error. If a permanent decrease in value is identified, then it is also necessary for a user to manually initiate an action in a system. If the complex checking means that a permanent decrease in value is not identified or is identified too late, this can suddenly have surprising and considerably negative effects on a company.

Thus, there is a need for a method, software application, and/or data processing system providing a more efficient solution of the above problems described above. In particular, it is desirable to provide methods and systems to automatically evaluate value changes of assets.

### SUMMARY OF THE INVENTION

Consistent with embodiments of the present invention, methods and systems are disclosed for automatically evaluating value changes for balance sheet objects.

According to one method consistent with the present invention, a book value is automatically determined for each object in an accounting system. A market value is also automatically determined for each object. An intermediate variable is automatically formed from the book value and the market value. The intermediate variable is automatically tested to determine whether it satisfies one or more presettable conditions. One or more actions are automatically performed depending upon the manner and/or degree to which one or more of the conditions are satisfied. Changed values of assets may automatically be incorporated into the accounting system.

In accordance with another embodiment of the invention, a computer system is provided for automatically incorporating value changes for balance sheet objects. The computer system may comprise: means for storing data; means for storing programs; means for executing programs; program code means for determining a book value for each object in an accounting system; program code means for determining a market value for each object; program code means for forming an intermediate variable from the book value and the market value; program code means for testing the intermediate variable to determine whether it satisfies one or more presettable conditions; and program code means for performing one or more actions depending upon the manner and/or degree to which one or more of the conditions are satisfied.

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings, which are incorporated in and constitute a part of this disclosure, illustrate embodiments and aspects of the present invention. In the drawings:

FIG. 1 shows a schematic illustration of an exemplary computer system comprising a program consistent with an embodiment of the invention.

### DETAILED DESCRIPTION

Embodiments of the present invention include methods and systems for automatically incorporating value changes for balance sheet objects. In accordance with one embodiment, a book value for each object is automatically ascertained from an accounting system and a market value for each object is also automatically ascertained. An intermediate variable is automatically formed from the book value and the market value. The intermediate variable is automatically tested to determine whether it satisfies one or more preset conditions. One or more actions are automatically performed depending on the way and/or the degree to which one or more of the conditions are satisfied.

Embodiments consistent with the invention can be implemented using a computer system and an appropriately programmed computer program. A computer system within the context of the invention may comprise a computer, such as a personal computer (PC) or laptop, and associated peripherals. Alternatively, such a computer system may comprise a network containing a plurality of computers interconnected using the Internet or an intranet.

Embodiments consistent with the invention also encompass computer systems, computer programs, and computer program products for performing the methods and features disclosed herein. Embodiments of the invention also comprise computer programs on or embedded in a data storage medium that can be used to load programs into a computer and to perform methods consistent with the invention. For example, computer programs for performing such methods may be made up of one or more programs and/or program modules. They are subsequently referred to together as a “program.”

Wordings such as “the computer system” or “the program may . . . perform a particular action” or “a user may . . . perform a particular action”, “the program—or a user—does . . . this or that”, etc. and similar wordings are to be understood to mean that the program is programmed such that it or its embodiments can be used to perform the particular action automatically or on the basis of interaction between a user and the program when it is executed on the computer system.

The following detailed description refers to the accompanying drawings. Wherever possible, the same reference numbers are used in the drawings and the following description to refer to the same or similar parts. While several exemplary embodiments and features of the invention are described herein, modifications, adaptations and other implementations are possible, without departing from the spirit and scope of the invention. For example, substitutions, additions, or modifications may be made to the components illustrated in the drawings, and the exemplary methods described herein may be modified by substituting, reordering or adding steps to the disclosed methods. Accordingly, the following detailed description does not limit the invention. Instead, the proper scope of the invention is defined by the appended claims.

A first preferred embodiment is characterized in that the objects are securities. A second preferred embodiment is characterized in that the market value is the price of the object or the price of the security multiplied by the number of units available. In this case, the price may also be the current price or a daily price. A third preferred embodiment is characterized in that the intermediate variable is a difference between the book value and the market value. A further preferred embodiment is characterized in that the impairment price is the market price. The value adjustment may be either an increase in value or a decrease in value. Since a decrease in value is more risky, it is subsequently put in the foreground. For an increase in value, however, the features, steps and examples apply in a similar manner. An impairment is a specific case of a permanent alteration in value.

A further preferred embodiment is characterized in that the impairment price is a market price increased or reduced by a preset value. The preset value, which may also be a percentage, may also be chosen such that the object no longer satisfies any of the preset conditions after a value has been adjusted. In the aforementioned embodiments, the market price may be the current price or a daily price.

Methods consistent with the invention may be implemented using a computer-implemented accounting system, for example. A program can automatically query the book value and/or the acquisition value of the objects contained in the system from the database in the accounting system at settable intervals of time. Methods consistent with embodiments of the invention may also be implemented by automatically loading current values for one or more objects from a database that is available over the Internet. For example, the database may include the current prices of securities. The program takes the book values that have been read and the current prices and automatically calculates an intermediate variable. The intermediate value is preferably a difference between the book value and the market value that reflects the current loss in value. In this case, the book value, the acquisition value, and the market value preferably refer to the same time, which may be the current time, for example. By way of example, the book value of an object may change over time, such as a result of credit entries or transfer postings. The program automatically checks the intermediate variable to determine whether it satisfies one or more conditions implemented when the system is set up. One possible condition is to query whether the loss of value exceeds a certain, presettable sum within one or more presettable periods of time and whether the market price is below a certain, presettable value. These and all other indications of value too can naturally also be printed and calculated as percentages. Since the intermediate variable is subject to fluctuations, it is also possible to evaluate minimum and/or maximum and/or average values within one or more presettable periods of time and to check them to determine whether they satisfy one or more presettable conditions.

Suitable conditions are preferably queries regarding the disparity between the intermediate variable and an average value for the intermediate variable, ascertained over a settable period of time, by a presettable amount. The conditions also include queries regarding the disparity between the intermediate variable and a minimum disparity for the intermediate variable, ascertained over a settable period of time, by a presettable amount. The conditions further include queries regarding the disparity between the intermediate variable and a maximum disparity for the intermediate variable, ascertained over a settable period of time, by a presettable amount. And the conditions may include queries regarding the presettable number of disparities between the intermediate variable and a presettable auxiliary variable in a presettable period of time.

If one or more conditions have been satisfied, then, depending on the way in which and/or the degree each of the conditions is satisfied, one or more presettable actions are automatically performed that can be implemented when the system is set up, with the or each presettable action preferably being selected from a list comprising: calculation of an impairment price; sending of a message to a person; sending of a list containing proposals for action to a person; displaying advice regarding the way in which and/or the degree to which the or each of the conditions are satisfied on a display means, particularly a screen or a printout; performance of a value adjustment for the or each object in the company's accounting system.

In this context, the impairment price may be the market price. Alternatively, the impairment price may be above the current market price, specifically such that the object no longer satisfies any of the presettable conditions after a value adjustment has been performed using this increased price. To achieve this, the price may be iteratively increased in settable steps until none of the conditions are satisfied any longer after the value adjustment has been performed. The price calculated in this manner can be automatically proposed to a user for selection.

It is also possible to send a user a message, particularly an e-mail, which draws attention to the situation using a presettable standard text aligned with the condition in question. It is also possible to present a user with a list containing proposals for action, which are aligned with the respectively satisfied condition, for selection on a screen. By way of example, one or more impairment prices may be provided for entry. In addition, a display icon on a screen, which displays the book prices or values and/or the market prices or values of the objects in a company, can display advice drawing attention to the way in which and/or the degree to which the or each of the conditions are satisfied. For example, an icon such as a stylized traffic light may indicate an addition to the book price or market price. The traffic light can display “red” when a condition has arisen or “yellow” when a condition has almost arisen. When a condition has “almost” arisen, it is possible to define at system setup when a critical value has been reached by more than 80%, for example. In addition, it is possible to use, automatically, a calculated impairment price or an impairment price that has been presented and selected by a user in order to adjust the value of the or each object in the accounting system. To this end, the difference between an amortized acquisition value and the impairment value can be posted as an expense affecting net income, for example in an expense account. Reserves that have been formed can be liquidated so as to affect net income.

In the complete functional depiction of impairment in the course of the accounting operation of a company, the formation of impairments in line with US-GMP and IAS may be accompanied by asset management for an existing impairment in line with US-GAAP and IAS and the liquidation of impairments in line with IAS. In addition, there may be a suitable reporting mechanism for existing impairments. Furthermore, there may be means for transferring historical impairments that have already been implemented and managed to the system.

There may also be transactions for forming impairments and for canceling impairments that have been formed. In addition, there may be a maintenance transaction for manually inputting impairment prices or values. Further, relevant user interfaces for handling impairments are the change in the conditions in a generic type of object, for example in a loan agreement.

The statements below refer to the fact that an impairment is formed on the basis of a permanent decrease in value in the subsection, i.e., in the asset or purchase currency. The alternative, forming a valuation on the basis of a permanent decrease in value in the foreign exchange, i.e., in the valuation currency, if this is a foreign currency, is possible in a similar manner.

The level at which an impairment is formed can be an asset in a subledger in the account. In the case of securities, this can mean that an impairment is formed for an asset which is identified by a company code, a valuation range, a valuation class and an identification number and also differentiation terms (deposits, deposit group, portfolio, lot) stored in a customizing facility. In the case of loans, an impairment may be formed for an asset which is identified by company code, valuation range, valuation class and agreement number, i.e., for an agreement in a valuation range.

First, accounting and other systems consistent with embodiments of the invention can be used to store information describing the level of the probable permanent decrease in value. For this, the user can, in the case of securities, input a particular price, which may differ from the current market price. In the case of loans, a cash value may be stored. This “impairment price” or “impairment value” may be stored on the basis of the differentiations comprising company code, valuation range, valuation class and also identification number, deposits, deposit group, portfolio (securities) or agreement number (loans). Impairment prices or impairment values can thus be stored per asset. For manual input of the impairment prices or values, there may be a corresponding maintenance transaction in the system. Impairments may be implemented either on scheduled valuation key dates, such as the end of the month, the quarter or the year, or on other dates. Implementation of an impairment does not necessarily include the implementation of normal valuation steps, such as price valuation or foreign currency valuation. Thus, if an impairment is intended to be formed at a time at which a scheduled valuation is also taking place (e.g., end of quarter), two functions can be initiated separately, in which case first the impairment formation and then the valuation should always be performed.

It is advantageous for the implementation of an impairment for an asset (object) if either the asset management type “securities/loans/money dealings” or the asset management type “index bonds” is stored in the asset management method. It is possible to perform three steps: first amortization, then reset of all valuations not affecting net income in the subsection, and lastly depreciation affecting net income in the subsection.

If the asset management method for the corresponding asset stores an “amortization” step, then it is possible to perform amortization on the key date of the impairment formation. The movements needing to be generated in that case can be generated using the update types that are also used for a normal valuation.

If appreciations or depreciations not affecting net income have arisen for the asset (object) in the subsection in the past (either through key date valuations or transfer postings), then these can be reset. It is thus possible to use the two sums in the equity item's asset and valuation currency in the subsection and hence to generate a movement. If the two sums have different arithmetic signs, then two movements can be generated. When this step has been performed, the asset has an equity item not affecting net income in the subsection amounting to zero both in the asset currency and in the valuation currency. If there are no appreciation/depreciations not affecting net income in the subsection (this is possible, by way of example, in the case of an asset in the ‘held to maturity’ category), then nothing happens in this step. The update types can be used to generate the movements can be stored separately in the customizing facility (when the system is set up).

It is also possible to perform depreciation not affecting net income. This involves depreciation in the subsection. This is first calculated in the asset currency taking into account the previously stored impairment price or value and is then converted to valuation currency using the foreign exchange market price. The depreciation sums are used to generate a movement that is posted so as to affect net income. In the sum ledger, this depreciation resulting from an impairment is identified separately from the rest of the valuations. The update types used to generate the movements can be stored separately in the customizing facility. The basis for the depreciation affecting net income in the subsection is the explicitly stored impairment prices or values.

The book value of an asset can be in an asset currency and in a valuation currency. These two sums implicitly produce the “foreign exchange book price.” This implicit foreign exchange book price can be changed either by resetting the valuation not affecting net income in the subsection or by using the depreciation affecting net income in the subsection.

An impairment in the case of bonds frequently means aligning future sets of plans with interest or redemptions. This can be done by manually changing the conditions in the generic group. In this case, it should be remembered that such alignment operations have effects on all assets in the corresponding generic group, such as, for example, on all deposits and also on all valuation ranges. Effects of such alignment operations can arise, as discussed below.

An effect on the amortization for the impairment formation is normally not desired. Care should therefore be taken during the alignment operations to ensure that the calculated LAC or SAC values are not influenced. The depreciation affecting net income for the impairment formation is not affected by the alignment operations, since the depreciation is performed on the basis of an explicitly stored impairment price. The same applies to subsequent key date valuations.

As in the case of bonds, an impairment in the case of loans frequently means aligning future sets of plans with interest or redemptions. This can also be depicted manually using changed or new conditions. In this case, such alignment operations relate to all valuation ranges. Effects of such alignment operations can arise as described below.

An effect on the amortization for the impairment formation is normally not wanted. In the case of alignment operations, it is therefore necessary to ensure that the calculated LAC or SAC values are not influenced. A loan's cash value calculated by the system can be influenced by the alignment operations. If this cash value is used as an impairment value, then there may be effects on the depreciation affecting net income within the context of the impairment formation. These effects are normally wanted. If the key date valuation involves the use of the loan's cash value calculated by the system, then for the above reason (influence on the cash value) it is also possible to influence subsequent key date valuations. These effects are normally wanted.

For the function for forming an impairment, there will be an appropriate cancellation function. It is possible to cancel per asset. If there are key date valuations after the impairment that are canceled, then these can be canceled separately beforehand. Canceling an impairment entails cancellation of all derived business transactions (net income from prices) already booked which there may be afterwards.

The following description lists selected business transactions. It describes what effects these business transactions have on an existing impairment or what effects an existing impairment has on these business transactions.

Apart from one exception, the valuation of an asset with an existing impairment is performed in line with the settings in the associated asset management method. The exception exists in connection with amortizations. Amortizations are not performed for assets with an existing impairment, i.e., if this valuation step is stored in the asset management method, it is suppressed and a corresponding message is output in the valuation log. For an asset with an existing impairment, the resetting of a valuation works in a similar manner to the case with no impairment.

These statements mean, in particular, that, in the case of valuations, appreciations can arise in the subsection again, and that balances can also be built up again on the equity item not affecting net income subsection.

Asset outgoings in this case include the business transactions of redemption to be received, redemption to be paid, unscheduled redemption, sale, nominal alignment, and deposit outgoing. Asset incomings in this case include business transactions of payment (active), payment (passive), purchase, nominal alignment and deposit incoming.

For asset outgoings, an existing impairment is booked out from the asset in a nominal or unit-based proportion. An amortization within the context of generating the derived business transaction can be suppressed for an existing impairment. An asset incoming does not affect an existing impairment. An amortization arising on the basis of the incremental method is suppressed for an existing impairment.

In this case, transfer postings include the business transactions of deposit transfer, valuation class transfer and capital transfer. In the case of transfer postings, an existing impairment in the source asset is transferred to the destination asset in a nominal or unit-based proportion irrespective of the transfer type of the destination asset's asset management method.

If there is an impairment in the source asset (destination asset), then any waiting amortization is suppressed in the source asset (destination asset). If there is no impairment in the source asset (destination asset), then any waiting amortization is performed in the source asset (destination asset). These statements mean, in particular, that transfer postings can also result in impairments arising on an asset in the category trading.

The following capital measures can incorporate value adjustments formed and, in particular, impairments: share split, share exchange, capital reduction, capital increase from company means, conversion of issue currency, transfer of young shares to old shares, entry of subscription rights and other capital measures.

For the effect of capital measures on assets with an existing impairment, the following needs to be taken into account: if a capital measure were to alter the amortized acquisition value without impairment of an asset, then the amortized acquisition value including the impairment would need to be aligned in a similar manner. What this specifically means for the capital measures supported by the system is explained below.

A share split and a capital increase from a company is comparable to an incoming and has no influence on an existing impairment. A capital reduction has no effect on an existing impairment. A share exchange and a transfer of young shares to old shares are comparable to a transfer posting; an existing impairment is thus transferred in a unit based proportion from the source asset (outgoing share to be exchanged or young share) to the destination asset (incoming share to be exchanged or old share). If there is an impairment in the source asset (destination asset) in this context, then any waiting amortization is suppressed in the source asset (destination asset). If there is no impairment in the source asset (destination asset), then any waiting amortization is performed in the source asset (destination asset).

During conversion of the issue currency, an existing impairment is converted in a similar manner to the rest of the components of the asset. When entering subscription rights, any impairment existing on the share is transferred to the subscription right proportionally in a similar manner to the rest of the components. For any other capital measure, the procedure with an existing impairment is similar to how the treatment of amortized acquisition value without an impairment.

The following rights can incorporate value adjustments formed and, in particular, impairments: exercise warrant on shares, exercise warrant on interest, exercise warrant on index, exercise warrant on currency, exercise subscription right, exercise convertible bond, separate warrant bond, exercise putable bond, exercise callable bond and share exchange.

The following applies, in principle, for the effect of exercises of right on assets with an existing impairment: if the exercise of a right were to alter the amortized acquisition value without impairment of an asset, then the amortized acquisition value including the impairment would need to be aligned in a similar manner. What this specifically means for the rights supported by the system is explained below.

Exercising a warrant with physical delivery (on shares or on interest), exercising a subscription right, exercising a convertible bond and a share exchange are comparable to a transfer posting; an existing impairment is thus transferred from the source asset to the destination asset. If there is an impairment on a convertible bond, then any waiting amortization is suppressed during the exercise.

Exercising a warrant with a cash settlement (on shares, interest, index or currency) is comparable to an outgoing. An existing impairment is booked out. Exercising a putable or callable bond is comparable to an outgoing (bond is returned to issuer, right is with issuer (putable) or owner (callable)). An existing impairment is booked out. Any waiting amortization is suppressed for an existing impairment.

Separating a warrant bond can be regarded as a transfer posting with a source asset and two destination assets. An impairment existing on a warrant bond is transferred completely to a bond ex, i.e., the warrant has no impairment following separation. This procedure is similar to the amortization component, which is likewise transferred completely to the bond ex. All the remaining components can be distributed over the two destination assets, specifically in line with a ratio at the time of separation. If there is an impairment for the warrant bond, then any waiting amortization is suppressed.

There may also be means for evaluating the performed or existing impairment. This can be achieved by an asset component for performed impairments, which is available in asset development lists as a start, delta and end value. The value of this component goes into the amortized acquisition value, which is likewise available as a start, delta, and end value in asset development lists.

Accepting historical impairments is possible for an additional valuation range within the context of an initialization process. In this case, initial values proposed by the system may be used for the individual asset components or may be used in modified form. A historical impairment can in that case be set per asset on the ‘impairment’ component. Upon the asset initialization business transaction generated in a further step, the impairment is then automatically revealed to the appropriate asset in the subledger.

The advantages of the inventive methods or programs can essentially be seen in that it becomes possible for the first time to examine a multiplicity of objects or assets in accounting systems for permanent value change on a regular basis and with comparatively little expense. The automated checking allows conspicuous objects to be identified even before a balance sheet key date, which means that it is possible to react in good time. Possible reactions are, by way of example, performance of depreciations affecting net income in good time, sale or subsequent purchase of the objects in good time or transfer of the object. Since the consequences of a permanent decrease in value identified for objects too late have potentially surprising and considerable effects on a company that affects net income, the company's net income situation can be identified early.

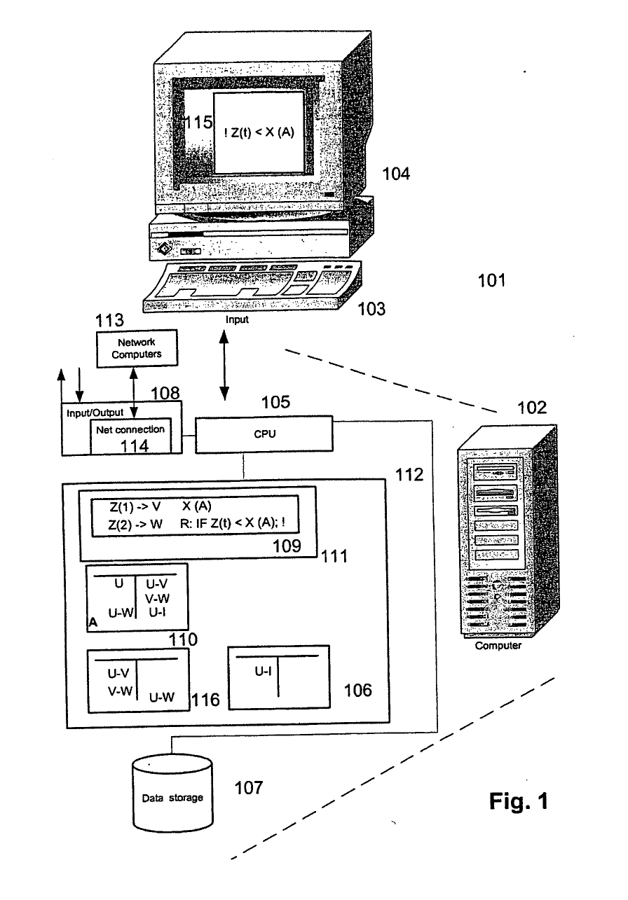

FIG. 1 shows a schematic illustration of an exemplary computer system comprising a program consistent with an embodiment of the invention. In particular, FIG. 1 shows a computer system 101 including a computer 102 that comprises a CPU 105 and a main memory 112 in which a program 111 for execution by the CPU 105 is loaded. In addition, there are input means 103, such as a keyboard, and output means 104, such as a monitor or display. The program 111 may comprise one or more programs or program modules 109, for carrying out methods consistent with the present invention. Loaded in the main memory are also an asset account 110, an expense account 106 and a reserve account 116, which can be accessed by the programs 109, 111. The accounts may also be stored in a data storage medium 107 for access and for editing.

The computer system 101 also comprises ordinary inputs and outputs 108 including a network connection 114 for connecting the computer 102 to identical or different computers or computer systems in the form of a network and/or to the Internet. In this case, the network computers may also be used as further input and/or output units for inputting and/or outputting data and for displaying input masks or for outputting results or for executing software. The data storage medium 107 may be used for permanently storing data. Such a computer system can be used to carry out methods consistent with the invention, as described by way of example below, without limiting embodiments of the invention.

By way of example, the program 111 may be implemented as accounting or financial software, having one (or more) module(s) 109 for carrying out methods consistent with the invention. The program 111 manages the asset account 110, in which an object A having a book value U has been entered. The module 109 first reads the book value of A and secondly, at a first time (1), a market price Y(1) in line with a value V for the object A which is smaller than U. Next, a reserve is formed in the reserve account 116 in line with the intermediate variable U-V, and is offset in the asset account 110. In addition, an impairment price Z(1) is formed which may be equal to Y(1) but which may also differ from Y(1). The module 109 automatically and regularly monitors the prices of the objects and accordingly reads a market price Y(2) with the value W of the object A, where W<V, at a second time (2). The value of A has thus decreased by the further sum V-W. Accordingly, a further provision V-W is formed in the reserve account 116 and is offset in the asset account 110. An impairment price Z(2) is also formed again. The module 109 automatically checks at regular intervals, at different times (t), whether the value of Z(t) satisfies a preset rule R. The rule R may state that if the impairment price Z(t) is below a preset value X, a warning 115 is output on the screen 104. In that case, automatically or following confirmation by a user, an impairment is formed by first calculating an impairment value (I) using the impairment price Z(t), then balancing the reserve account 116 with the asset account 110 (entry with sum U-W) and finally entering the value loss U-I into the expense account 106 which affects net income.

Programs consistent with the invention may be in the form of a source code, an object code or a mixed code, fully or partially in compiled form. The data storage medium can be any unit or apparatus which is suitable for holding a program: ROM, e.g., CD-ROM or a semiconductor ROM or DVD ROM, a magnetic storage medium, e.g., floppy disk or hard disk, a transmittable carrier, such as an electrical or optical signal which can be transmitted over electrical or optical lines, or using electromagnetic waves such as radio or radio waves, or another suitable carrier. If the program is held in a signal which is routed via a cable or another means or medium, the cable or the other means or medium can be the data storage medium. Alternatively, the program may be embedded in an integrated circuit provided for carrying out methods consistent with the present invention.

The follow terms used in the above-description are defined below:

Asset: An asset is an evaluatable unit, for example a loan in a valuation range or a security in a deposit and a valuation range.

Asset component: The values of an asset are divided into asset components (e.g., acquisition value, book value). Each asset component carries a value in the asset currency and in the valuation currency.

Acquisition value: Asset component which contains the purchase value of the asset and the costs incurred for the incomings.

Amortization: The amortization distributes an existing premium or discount over the retention period. Amortization is also understood to mean the asset component which contains the results of amortizations performed.

Amortized acquisition value: Asset component which contains the sum comprising acquisition value, amortization and impairment.

Book value: Asset component which contains the amortized acquisition value and the results of all valuations performed (e.g., valuation in the subsection, valuation in the foreign exchange).

Asset currency: Any asset component carries, inter alia, a value in asset currency. The asset currency is the currency of issue for securities, for example.

Valuation currency: Any asset component carries, inter alia, a value in valuation currency. The valuation currency is the currency in which a company balances accounts in a valuation range.

Asset management method: The asset management method stipulates what steps are taken when valuing an asset or when ascertaining the derived business transactions for an asset and in what order the steps need to be performed.

Valuation in the subsection or price valuation: Valuation in the subsection or price valuation is understood to mean the result of the comparison between market value and book value for an asset taking into account particular valuation rules. Subsection valuation is also understood to mean the asset component which contains the results of price valuations performed.

Valuation in the foreign exchange or foreign currency valuation: Valuation in the foreign exchange or foreign currency valuation is understood to mean the result of the comparison between the foreign currency market price and the foreign currency book price of an asset taking into account particular valuation rules. Foreign exchange valuation is also understood to mean the asset component which contains the results of foreign currency valuations performed.

Valuation range: Valuation ranges are used to allow the assets to be allocated to various account rendering specifications (e.g., HGB, IAS, US-GAAP).

Market price: Price of a security at a marketplace.

Market value: The market value of an asset is the market price multiplied by the quantity available (e.g., number of shares).

Impairment price: Price at which an impairment is to be performed

Impairment value: The impairment value of an asset is the impairment price multiplied by the quantity available (e.g., number of shares).

Derived business transaction: When a business transaction is performed for an asset (e.g., incoming, outgoing, transfer posting), a derived business transaction is generated for it which, by way of example, contains the net income from prices which results from the business transaction.

While certain features and embodiments of the invention have been described, other embodiments of the invention will be apparent to those skilled in the art from consideration of the specification and practice of the embodiments of the invention disclosed herein. Furthermore, although embodiments of the present invention have been described as being associated with data stored in memory and other storage mediums, one skilled in the art will appreciate that these aspects can also be stored on or read from other types of computer-readable media, such as secondary storage devices, like hard disks, floppy disks, or a CD-ROM, a carrier wave from the Internet, or other forms of RAM or ROM. Further, the steps of the disclosed methods may be modified in any manner, including by reordering steps and/or inserting or deleting steps, without departing from the principles of the invention.

It is intended, therefore, that the specification and examples be considered as exemplary only, with a true scope and spirit of the invention being indicated by the following claims and their full scope of equivalents.

What is claimed is:

1. A method for automatically evaluating value changes of balance sheet objects, the method comprising:
automatically determining a book value for each object in an accounting system;
automatically determining a market value for each object;
automatically forming an intermediate variable from the book value and the market value;
automatically testing the intermediate variable to determine whether it satisfies one or more presettable conditions; and
automatically performing one or more actions depending upon the manner and/or degree to which one or more of the presettable conditions are satisfied.

2. The method according to claim 1, wherein the objects are securities.

3. The method according to claim 1, wherein the market value is the price of the object multiplied by the number of units available.

4. The method according to claim 1, wherein the intermediate variable is a difference between the book value and the market value.

5. The method according to claim 1, wherein the one or more presettable conditions are selected from a list comprising:
disparity between the intermediate variable and an average value for the intermediate variable, ascertained over a settable period of time by a presettable amount;
disparity between the intermediate variable and a minimum disparity for the intermediate variable, ascertained over a settable period of time by a presettable amount;
disparity between the intermediate variable and a maximum disparity for the intermediate variable, ascertained over a settable period of time by a presettable amount; and
presettable number of disparities between the intermediate variable and a presettable auxiliary variable in a presettable period of time.

6. The method according to claim 1, wherein each action is selected from a list comprising:
calculating an impairment price;
sending a message to a person;
sending a list containing proposals for action to a person;
presenting advice for a degree to which the conditions are satisfied on a display; and
performing a value adjustment for each object in the accounting system.

7. The method according to claim 6, wherein the impairment price is the market price.

8. The method according to claim 6, wherein the impairment price is a market price increased or reduced by a presettable value.

9. A computer system for performing a method for automatically evaluating value changes of balance sheet objects, the computer system comprising:
means for storing data;
means for storing programs;
means for executing programs;
program code means for determining a book value for each object in an accounting system;
program code means for determining a market value for each object;
program code means for forming an intermediate variable from the book value and the market value;
program code means for testing the intermediate variable to determine whether it satisfies one or more presettable conditions; and
program code means for performing one or more actions depending upon the manner and/or degree to which one or more of the presettable conditions are satisfied.

10. The computer system according to claim 9, wherein the objects are securities.

11. The computer system according to claim 9, wherein the market value is the price of the object multiplied by the number of units available.

12. The computer system according to claim 9, wherein the intermediate variable is a difference between the book value and the market value.

13. The computer system according to claim 9, wherein the one or more presettable conditions are selected from a list comprising:
disparity between the intermediate variable and an average value for the intermediate variable, ascertained over a settable period of time by a presettable amount;
disparity between the intermediate variable and a minimum disparity for the intermediate variable, ascertained over a settable period of time by a presettable amount;
disparity between the intermediate variable and a maximum disparity for the intermediate variable, ascertained over a settable period of time by a presettable amount; and
presettable number of disparities between the intermediate variable and a presettable auxiliary variable in a presettable period of time.

14. The computer system according to claim 9, wherein each action is selected from a list comprising:
calculating an impairment price;
sending a message to a person;
sending a list containing proposals for action to a person;
presenting advice for a degree to which the conditions are satisfied on a display; and
performing a value adjustment for each object in the accounting system.

15. The computer system according to claim 14, wherein the impairment price is the market price.

16. The computer system according to claim 14, wherein the impairment price is a market price increased or reduced by a presettable value.

17. A computer readable medium containing instructions for performing a method for automatically evaluating value changes of balance sheet objects, the method comprising:
automatically determining a book value for each object in an accounting system;
automatically determining a market value for each object;
automatically forming an intermediate variable from the book value and the market value;
automatically testing the intermediate variable to determine whether it satisfies one or more presettable conditions; and
automatically performing one or more actions depending upon the manner and/or degree to which one or more of the presettable conditions are satisfied.

18. The computer readable medium according to claim 17, wherein the objects are securities.

19. The computer readable medium according to claim 17, wherein the market value is the price of the object multiplied by the number of units available.

20. The computer readable medium according to claim 17, wherein the intermediate variable is a difference between the book value and the market value.

21. The computer readable medium according to claim 17, wherein the one or more presettable conditions are selected from a list comprising:
disparity between the intermediate variable and an average value for the intermediate variable, ascertained over a settable period of time by a presettable amount;
disparity between the intermediate variable and a minimum disparity for the intermediate variable, ascertained over a settable period of time by a presettable amount;
disparity between the intermediate variable and a maximum disparity for the intermediate variable, ascertained over a settable period of time by a presettable amount; and
presettable number of disparities between the intermediate variable and a presettable auxiliary variable in a presettable period of time.

22. The computer readable medium according to claim 17, wherein each action is selected from a list comprising:
calculating an impairment price;
sending a message to a person;
sending a list containing proposals for action to a person;
presenting advice for a degree to which the conditions are satisfied on a display; and
performing a value adjustment for each object in the accounting system.

23. The computer readable medium according to claim 22, wherein the impairment price is the market price.

24. The computer readable medium according to claim 22, wherein the impairment price is a market price increased or reduced by a presettable value.
